(19) United States
(12) Patent Application Publication
(10) Pub. No.: US 2026/0145351 A1
(43) Pub. Date: May 28, 2026

(54) SLICING MACHINE

(71) Applicant: MULTIVAC SEPP HAGGENMÜLLER SE & CO. KG, Wolfertschwenden (DE)

(72) Inventor: Christian DERSCH, Wolfertschwenden (DE)

(73) Assignee: MULTIVAC SEPP HAGGENMÜLLER SE & CO. KG, Wolfertschwenden (DE)

(21) Appl. No.: 19/397,786

(22) Filed: Nov. 21, 2025

(30) Foreign Application Priority Data
Nov. 22, 2024 (DE) 102024134451.2

(51) Int. Cl. B26D 7/06; B26D 7/02; B26D 7/01

(52) U.S. Cl. CPC B26D 7/0625; B26D 7/02; B26D 2007/011; B26D 2210/02

(57) ABSTRACT

A slicing machine for slicing at least one product caliber comprises: a feed unit designed to feed the at least one product caliber along a feed direction. The feed unit comprises a product support device for the at least one product caliber, and a cutting unit designed to slice the at least one product caliber into slices. The feed unit comprises, in the region of the cutting unit, a product guide device designed to restrict movement of the at least one product caliber substantially transversely to the feed direction. The feed unit furthermore comprises a further product guide unit arranged, in relation to the feed direction, upstream of the product guide unit and located opposite the product support device. The further product guide unit is connected to the product support device so that they can pivot, preferably only jointly, about a swivel axis running substantially orthogonal to the feed direction.

### CROSS-REFERENCE TO RELATED APPLICATIONS

This application claims foreign priority benefits under 35 U.S.C. § 119(a)-(d) to German patent application number 102024134451.2, filed November 22, 2024, which is incorporated by reference in its entirety.

### SUMMARY

The disclosure relates to a slicing machine, in particular a slicer, for slicing at least one product caliber, comprising:

a feed unit, which is designed to feed the at least one product caliber along a feed direction, wherein the feed unit comprises a product support device for the at least one product caliber, and

a cutting unit, which is designed to slice the at least one product caliber into slices , wherein the feed unit comprises, in the region of the cutting unit, a product guide unit that is designed to limit movement of the at least one product caliber substantially transversely, preferably orthogonal, to the feed direction.

It should already be noted at this point that the slicing machine is provided according to the disclosure for slicing foodstuffs, in the form of at least one so-called product caliber, into slices, from which preferably shingled or stacked portions can be formed. The at least one product caliber can in this connection be formed, for example, from sausage, cheese, grown meat, pressed meat, and the like. The feed unit of the slicing machine can be designed, for example, as an endlessly circulating belt conveyor or the like. The cutting unit is preferably arranged downstream of the feed unit with respect to the feed direction. The cutting unit can comprise a knife that can be rotatably driven about a rotation axis. By means of the knife, the slices can be separated from an end of the at least one product caliber facing the cutting unit.

All of this also applies to the slicing machine according to the disclosure.

It is in principle known to provide a product guide unit in the region of the cutting unit, which is designed to limit a movement of the at least one product caliber substantially transversely to the feed direction, so as to be able to guide the movement of the at least one product caliber reliably and precisely during slicing. Generic slicing machines generally comprise a product support device upstream of the product guide unit in relation to the feed direction, on which the at least one product caliber can rest. The product support device can be designed, for example, as an endlessly circulating belt conveyor or the like in order to be able to move the at least one product caliber, in particular a front end thereof, first of all to the product guide unit and then further along to the cutting unit. The product guide unit can, for example, also comprise one or more belt conveyors and/or sliding guides.

In order to be able to automate a loading process of the slicing machine, the product support device is preferably able to pivot about a pivot axis substantially orthogonal to the feed direction, in particular about a substantially horizontally extending pivot axis, namely between an inclined slicing position, in which the product support device has a gradient in the feed direction, and a loading position, in which the product support device can be aligned substantially parallel to a base of the slicing machine. The disadvantage in this case is that the at least one product caliber usually rests just on the product support unit during a loading procedure and therefore a movement of the at least one product caliber substantially transversely, preferably orthogonally, to the feed direction during the pivoting movement from the loading position to the slicing position is not or is only insufficiently guided and/or fixed.

An object of the present disclosure is therefore to remedy this situation, in particular by providing a slicing machine in which a safe and reliable guidance of a movement of the at least one product caliber, in particular substantially transversely, preferably orthogonally, to the feed direction can be ensured during the loading process and also during the slicing process.

This object is achieved according to the disclosure by a slicing machine of the type mentioned in the introduction, in which the feed unit furthermore comprises a further product guide unit, which is arranged upstream of the product guide unit with respect to the feed direction and is located opposite the product support device, and the further product guide unit is connected to the product support device in such a way that they can be pivoted, preferably only jointly, about a pivot axis running substantially orthogonally to the feed direction.

Since, according to the disclosure, the feed unit furthermore comprises the further product guide unit, which together with the product support device can pivot about the pivot axis running substantially orthogonally to the feed direction, a safe and reliable guidance of the movement of the at least one product caliber, in particular substantially transversely, preferably orthogonally, to the feed direction can be ensured at all times, i.e. during loading of the slicing machine with the at least one product caliber and also during slicing of the at least one product caliber.

Also, the further product guide unit is preferably designed accordingly so as to limit the movement of the at least one product caliber substantially transversely, preferably orthogonally, to the feed direction.

Preferably, the further product guide unit can pivot only together with the product support device about the pivot axis running substantially orthogonally to the feed direction. Accordingly, the further product guide unit and the product support device can preferably pivot about the pivot axis running substantially orthogonally to the feed direction by means of one and the same actuator of the slicing machine, such as an electric or pneumatic actuator.

Furthermore, the pivot axis extending substantially orthogonally to the feed direction is preferably a pivot axis that runs substantially horizontally.

The product guide unit in the region of the cutting unit can however be designed in such a way that a movement of the product guide unit is decoupled from the pivoting movement of the product support device and/or the further product guide unit about the pivot axis running substantially orthogonally to the feed direction. The product guide unit can preferably be arranged on the slicing machine in a non-pivotable manner. However, it is conceivable that at least a part of the product guide unit, preferably a first, in particular upper, product guide device of the product guide unit, is displaceable and/or adjustable along a height direction of the at least one product caliber.

In principle, portions can be formed from the slices cut by the cutting unit, in particular by means of a portioning means, such as a portioning belt. A portion can comprise one or more slices.

Furthermore, the slicing machine can comprise a control unit, which can be designed to control at least the feed unit, the cutting unit, and also preferably all other movable parts of the slicing machine.

In principle, the joint pivoting of the product support device and the further product guide unit can be implemented as desired in any structural manner. However, according to an exemplary embodiment, it is proposed that the further product guide unit is fixedly connected to the product support device with regard to its pivotability about the pivot axis running substantially orthogonally to the feed direction. In this way a pivoting movement of the product support device can also easily be transmitted to the further product guide unit, and vice versa. If desired, the further product guide unit can also be completely fixedly connected to the product support device.

In order to realize the joint pivotability of the further product guide unit and the product support device in a structurally simple and reliable manner, according to one exemplary embodiment the further product guide unit and the product support device can be arranged on a common support that can pivot about the pivot axis running substantially orthogonally to the feed direction.

However, in order to be able to adapt the further product guide unit also to varying product caliber heights, according to a further exemplary embodiment it is proposed that a distance between the further product guide unit and the product support device is adjustable. The distance can be measured in a direction that extends orthogonally to the feed direction, so that the distance can substantially correspond to a height of the at least one product caliber.

If the further product guide unit and the product support device are arranged on the common support, the distance can preferably be adjusted if the further product guide unit is displaceably arranged on the support, preferably in a height direction of the at least one product caliber. The height direction can correspond to a direction that runs orthogonally to both the pivot axis and the feed direction.

If the at least one product caliber is to be held during feeding and/or slicing, for example, by a gripper of a gripper unit of the slicing machine, in order to execute a gripping operation of the gripper it may be necessary to at least temporarily limit the movement of the at least one product caliber in the feed direction. According to one exemplary embodiment, it can therefore be envisaged to provide a stop element in the feed direction between the product guide unit and the further product guide unit, which can be adjusted between a locking position, in which a movement of the at least one product caliber toward the cutting unit is limited, and a release position, in which movement of the at least one product caliber toward the cutting unit is released. Also, the product guide unit arranged in the region of the cutting unit then preferably does not necessarily have to be designed so as to be able to pivot about a substantially horizontally extending axis in order to be able to provide such a stop, since the stop can be provided by the stop element itself. The movement of the stop element between the locking position and the release position can be implemented by an electric drive unit or the like.

According to a development of the last-mentioned exemplary embodiment, the stop means can be designed as a slider, which can be driven, preferably translationally, between the locking position and the release position. Preferably the slider can be driven in a substantially rectilinear direction, the slider being arranged however in particular in a non-pivotable manner on the slicing machine.

According to yet a further development, it is proposed that the slider is arranged in the release position, preferably completely above or below a support plane of the product support device, whereby an orderly and smooth guidance of the at least one product caliber can be ensured.

In order to be able to guide the at least one product caliber in the region of the cutting unit, preferably directly in front of it, from at least two sides, the product guide unit can comprise a first product guide device as well as a second product guide device arranged opposite the first product guide device. In this connection, the first product guide device can be designed as an upper product guide device and/or the second product guide device can be designed as a lower product guide device, or vice versa.

In order to guide the at least one product caliber by means of the product guide unit or the further product guide unit not only substantially transversely, preferably orthogonally, to the feed direction, but also to be able to move it in and/or counter to the feed direction, according to a further exemplary embodiment it is proposed that the product guide unit, in particular the first product guide device and/or the second product guide device, and/or the further product guide unit, be designed as a preferably endlessly circulating belt conveyor. Each belt conveyor can, in a generally known manner, comprise, for example, two opposing deflection rollers or pulleys around which a continuously driven conveyor belt can run. For this purpose, at least one of the two deflection rollers or pulleys can be driven about its axis of rotation, for example, using an electric drive unit or the like.

According to a further exemplary embodiment, it is proposed that the slicing machine further comprises a gripper unit with at least one gripper that is designed to hold the at least one product caliber at an end thereof facing away from the cutting unit. The gripper can comprise gripper claws that are adjustable between an engagement position, in which the gripper claws engage with the at least one product caliber, and a release position, in which the gripper claws release the at least one product caliber. Furthermore, the gripper unit can be displaceable substantially in or against the feed direction, in particular by means of a, preferably electric, drive unit or the like.

Furthermore, the product support device can pivot in a manner known per se about the pivot axis between an inclined slicing position, in which the product support device has a gradient in the feed direction, and a loading position, in which the product support device can be aligned substantially parallel to a base of the slicing machine, and preferably substantially horizontally.

It should also be noted that the slicing machine can furthermore comprise a portioning device that is designed to form portions from the slices cut by the cutting unit and to convey the portions along a discharge direction, in particular to a further processing device, for example a packaging machine, such as a thermoform packaging machine or the like. Furthermore, each portion can comprise one or more slices.

Finally, the slicing machine can be designed as a single-track or multi-track slicing machine.

### BRIEF DESCRIPTION OF THE DRAWINGS

Exemplary embodiments according to the disclosure will be explained in more detail hereinafter with reference to the accompanying drawings, in which:

FIG. 1a is a schematic side view of a slicing machine according to the disclosure according to an exemplary embodiment, in which a product support device of the slicing machine is in an inclined slicing position;

FIG. 1b is a schematic side view according to FIG. 1a, in which however the product support device is pivoted into a loading position starting from FIG. 1a; and

FIG. 2 is a schematic plan view of the slicing machine according to FIGS. 1a and 1b

### DETAILED DESCRIPTION

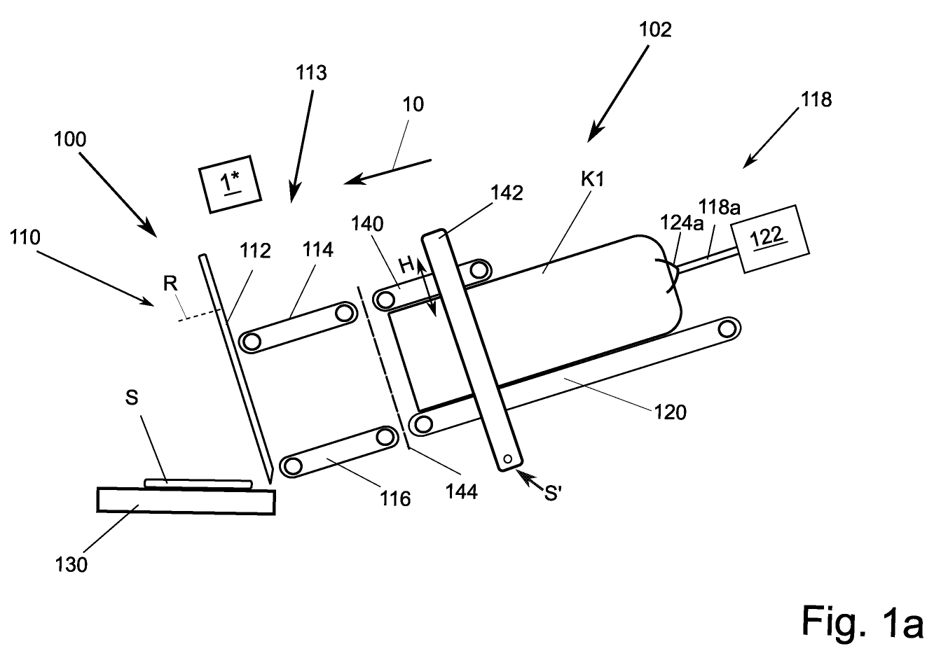

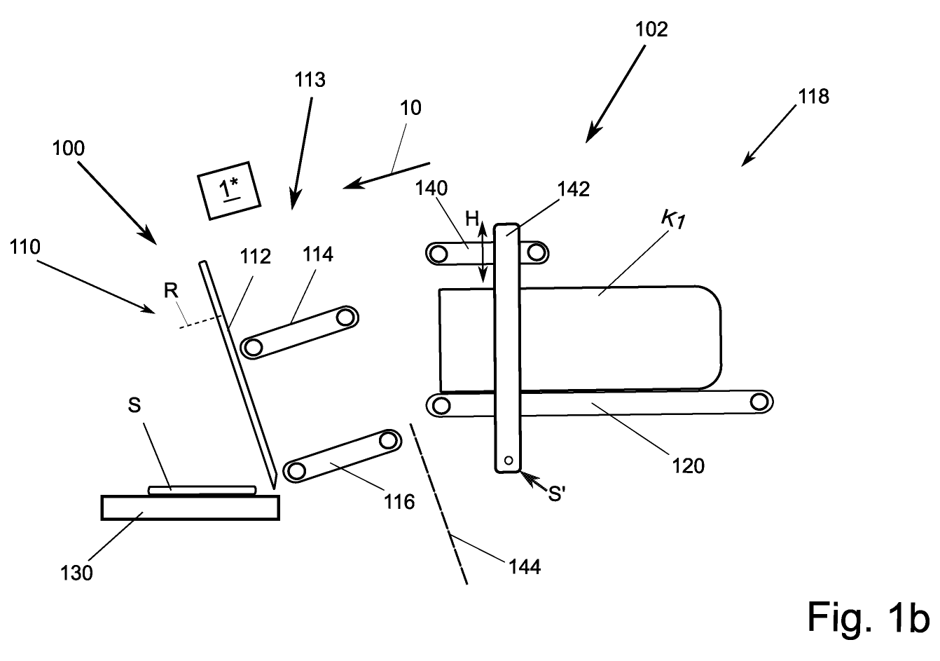

In FIGS. 1a and 1b a slicing machine according to an exemplary embodiment in accordance with the disclosure is generally designated by the reference numeral 100.

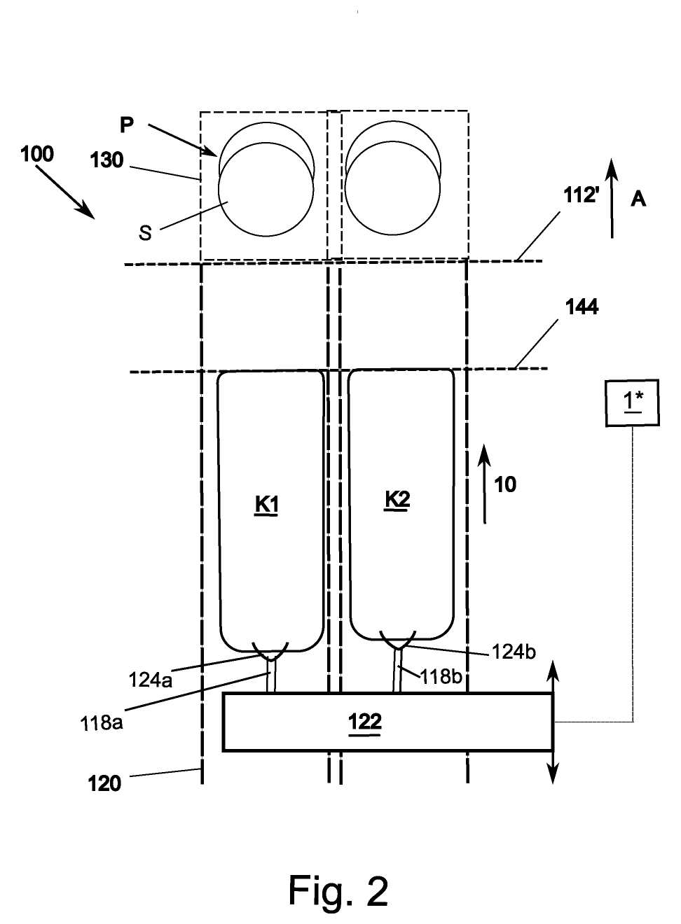

The slicing machine 100 can be designed as a single-track or multi-track slicing machine and is illustrated in the present case by way of example as a two-track slicing machine 100 (see in particular FIG. 2), only one track of the slicing machine 100 being recognizable in the side views according to FIGS. 1a and 1b.

The slicing machine 100 comprises a feed unit 102, which is designed to feed at least one product caliber (e.g., elongated product), in the present exemplary embodiment the product calibers K1 and K2, along a feed direction 10 to a cutting unit 110. The cutting unit 110 can comprise a knife 112, which is movable in a cutting plane 112', in particular can be rotatably driven about a rotation axis R, for example by means of an electric drive unit (not shown). The knife 112 can, for example, be designed as a sickle knife, which preferably has a radius that varies around

the rotation axis R, in particular increases in the direction of rotation about the rotation axis R. Consequently, the knife 112 can initially open up a cutting gap during a partial rotation about the rotation axis R and enable the product calibers K1, K2 to advance in the feed direction 10, and can then cut a slice S from the product caliber K1 and/or K2 on further rotation about the rotation axis R. A cutting frame (not shown) with corresponding openings for the product calibers K1 and K2 can be arranged slightly upstream of the knife 112 in the feed direction 10, which can serve as a counter edge for the knife 112 during the cutting procedure.

At a front end, the product calibers K1 and K2 can be guided by a product guide unit 113, which is arranged in the region of the cutting unit 110 and is designed to limit a movement of the product calibers K1 and K2 substantially transversely, in the illustrated exemplary embodiment substantially orthogonally, to the feed direction 10. In the illustrated exemplary embodiment the product guide unit 113 comprises a first product guide device 114 and a second product guide device 116, which is arranged opposite the first product guide device 114. The first product guide device 114 corresponds in this case to an upper product guide device, while the second product guide device 116 corresponds to a lower product guide device. In the illustrated exemplary embodiment the upper product guide device 114 and the lower product guide device 116 are designed as continuously circulating belt conveyors, each having two oppositely arranged deflection pulleys, as schematically indicated in FIGS. 1a and 1b. At least one of the deflection pulleys of each of the belt conveyors of the first 114 or the second 116 product guide device can be rotatably driven in, and preferably counter to, the feed direction 10.

In addition, the slicing machine 100 can comprise a gripper unit 118 with grippers 118a and 118b (see in particular FIGS. 1a and 2), wherein each gripper 118a, 118b can be designed to grip the product caliber K1 or K2 at an end facing away from the cutting unit 110. The gripper unit 118 is not shown in FIG. 1b for the sake of clarity.

Before and during slicing, the product calibers K1 and K2 can rest on a product support device 120 of the feed unit 102, which in the illustrated exemplary embodiment is also designed as a continuously circulating belt conveyor.

Furthermore, a control unit 1* of the slicing machine 100 is schematically indicated in FIGS. 1a, 1b, and 2, by means of which the cutting unit 110 and also the feed unit 102 of the slicing machine 100, as well as preferably all other moving parts of the slicing machine 100, can be controlled.

In FIG. 2 a cutting plane 112' of the knife 112 is simply schematically indicated by dashed lines. By means of the knife 112, slices S can accordingly be cut from the product calibers K1 and K2 by a rotational movement along the cutting plane 112'. The slices S can fall onto a portioning unit 130. For example, by stacking or shingling several slices S, corresponding portions P can be formed on the portioning unit 130. The portioning unit 130 can in this connection be designed as a portioning belt, for example in the form of a conveyor belt or the like. From the portioning unit 130, the portions P can be conveyed along a discharge direction A (see FIG. 2) to a feed collection unit in the form of a belt feed collection device or the like, which can be designed to feed the portions P to a downstream processing device in the form of a packaging machine or the like, which however are not illustrated here.

A special feature of the slicing machine 100 according to the present exemplary embodiment is the fact that the feed unit 102 also comprises a further product guide unit 140, which is arranged upstream of the product guide unit 113 with respect to the feed direction 10 and is located opposite the product support device 120. The further product guide unit 140 is connected to the product support device 120 in such a way that they can pivot, preferably only jointly, about a pivot axis S' running substantially orthogonally to the feed direction 10. The further product guide unit 140 can be designed as an endlessly circulating belt conveyor, similar to the upper product guide device 114 or the lower product guide device 116.

The joint pivotability of the further product guide unit 140 and the product support device 120 can be achieved by the fact that they are fixedly connected to one another with regard to pivotability about the pivot axis S' running substantially orthogonally to the feed direction 10. In the illustrated exemplary embodiment, the further product guide unit 140 and the product support device 120 are arranged on a common support or support base142 (e.g., beam, bar, rod, etc.) which can pivot about the pivot axis S' running substantially orthogonally to the feed direction 10, which is shown schematically in FIGS. 1a and 1b. The support 142 can be connected to a frame (not shown) of the slicing machine 100 standing on a base and can pivot about the pivot axis S' relative to the frame by means of a corresponding actuator.

The product support device 120 can pivot about the pivot axis S' at least between a slicing position shown in FIG. 1a, in which the product support device 120 has a gradient in the feed direction 10, and a loading position shown in FIG. 1b, in which the product support device 120 can be aligned substantially parallel to the base of the slicing machine 100, and in the illustrated exemplary embodiment substantially horizontally.

Preferably, a distance between the further product guide unit 140 and the product support device 120 can be adjustable, which in turn can be realized if the further product guide unit 140 is arranged displaceably on the support 142 in and preferably counter to a height direction H of the product calibers K1, K2. The displaceability can be achieved, for example, by a displacement mechanism, not shown in detail in FIGS. 1a and 1b, which can, for example, comprise an electric motor and preferably a corresponding gear unit to effect the displacement of the further product guide unit 140 along the height direction H.

As can also be seen in FIGS. 1a and 1b, in the illustrated exemplary embodiment a stop element 144 in the form of a slider is provided in the feed direction 10 between the product guide unit 113 and the further product guide unit 140, which stop element can be adjusted, preferably translationally, between a locking position shown in FIG. 1a, in which movement of the product calibers K1, K2 toward the cutting unit 110 is limited, and a release position shown in FIG. 1b, in which movement of the product calibers K1, K2 toward the cutting unit 110 is released.

As can be seen in FIG. 1b, the slider 144 is preferably arranged in the release position below a support plane of the product support device 120 in order to release the movement of the product calibers K1 and K2 toward the cutting unit 110. Alternatively, the slider 144 can however obviously also be located above the product support device 120 in the release position, and in this connection preferably also above or at least at the same height as the upper product guide device 114 and the further product guide unit 140.

As can be seen in FIG. 2, the slicing machine 100 can furthermore comprise a gripper carriage 122, which can be arranged on the slicing machine 100 so that it can be driven in and

against the feed direction 10. By moving the gripper carriage 122, on which the grippers 118a and 118b are arranged, the grippers 118a and 118b can be moved accordingly in and against the feed direction 10. It should be noted that gripper claws 124a of the gripper 118a and/or gripper claws 124b of the gripper 118b can be adjusted between an engagement position, in which they engage with the respective product caliber K1 or K2, as shown in FIG. 2, and a release position (not shown), in which they release the respective product caliber K1 or K2.

The slider 144 is also only shown schematically in FIG. 2. The product guide unit 113 and the further product guide unit 140 are also not shown in FIG. 2, for the sake of clarity.

What is claimed is:

1. A slicing machine for slicing at least one product caliber, comprising:
a feed unit which is designed to feed the at least one product caliber along a feed direction, wherein the feed unit comprises a product support device for the at least one product caliber; and
a cutting unit which is designed to cut the at least one product caliber into slices;
wherein the feed unit comprises, in a region of the cutting unit, a product guide unit which is designed to limit a movement of the at least one product caliber substantially transversely to the feed direction, and wherein the feed unit furthermore comprises a further product guide unit which, with respect to the feed direction, is arranged upstream of the product guide unit and opposite the product support device, and the further product guide unit is connected to the product support device in such a way that the further product guide and the product support device are pivotable about a pivot axis running substantially orthogonally to the feed direction.

2. The slicing machine according to claim 1, wherein the further product guide unit and the product support device are pivotable only jointly about the pivot axis.

3. The slicing machine according to claim 1, wherein the further product guide unit is fixedly connected to the product support device with respect to pivotability of the product support device about the pivot axis.

4. The slicing machine according to claim 1, wherein a distance between the further product guide unit and the product support device is adjustable.

5. The slicing machine according to claim 1, wherein the further product guide unit and the product support device are arranged on a common support base that is pivotable about the pivot axis.

6. The slicing machine according to claim 5, wherein the further product guide unit is arranged on the support base so as to be displaceable.

7. The slicing machine according to claim 6, wherein the further product guide unit is displaceable in a height direction of the at least one product caliber.

8. The slicing machine according to claim 6, wherein the further product guide unit is displaceable toward and away from the product support device.

9. The slicing machine according to claim 1, further comprising a stop element provided in the feed direction between the product guide unit and the further product guide unit, wherein the stop element is adjustable between a locking position, in which a movement of the at least one product caliber towards the cutting unit is limited, and a release position, in which the movement of the at least one product caliber towards the cutting unit is released.

10. The slicing machine according to claim 9, wherein the stop element is designed as a slider, which is movable between the locking position and the release position.

11. The slicing machine according to claim 10, wherein the slider is movable translationally between the locking position and the release position.

12. The slicing machine according to claim 10, wherein the slider is arranged above or below a support plane of the product support device in the release position.

13. The slicing machine according to claim 1, wherein the product guide unit comprises a first product guide device as well as a second product guide device located opposite the first product guide device.

14. The slicing machine according to claim 1, wherein the product guide unit or the further product guide unit comprises a belt conveyor.

15. The slicing machine according to claim 1, further comprising a gripper unit with at least one gripper which is designed to hold the at least one product caliber at an end thereof facing away from the cutting unit.

16. The slicing machine according to claim 1, wherein the product support device is pivotable about the pivot axis between an inclined slicing position, in which the product support device has a gradient in the feed direction, and a loading position, in which the product support device is aligned substantially parallel to a base of the slicing machine.

17. The slicing machine according to claim 1, further comprising a portioning device which is designed to form portions from the slices cut by the cutting unit and to convey the portions away along a discharge direction.
